(19) United States
(12) Patent Application Publication
(10) Pub. No.: US 2005/0265697 A1
(43) Pub. Date: Dec. 1, 2005

(54) METHOD OF ENCODING AND DECODING AUDIO-VISUAL INFORMATION AND RECORDING MEDIUM STORED WITH FORMATTED AUDIO-VISUAL INFORMATION

(76) Inventors: Chieh-Chung WANG, Hsinchu City (TW); Li-Shin HUANG, Taipei County (TW); Kuang-Hsing LI, Miaoli County (TW)

Correspondence Address: NORTH AMERICA INTELLECTUAL PROPERTY CORPORATION, P.O. BOX 506, MERRIFIELD, VA, 22116, US

(21) Appl. No.: 10/711,312

(22) Filed: Sep. 10, 2004

(30) Foreign Application Priority Data
May 26, 2004 (TW) 093114916

(51) Int. Cl. H04N 7/52

(52) U.S. Cl. 386/96

(57) ABSTRACT

Audio-visual information is recorded in a recording medium. The audio-visual information is formatted by at least one universal audio-video frame (UAVF) consisting of at least one synchronization-audio packet (SAP), at least one control-audio packet (CAP), and at least one video-audio packet (VAP). The SAP has at least one synchronization data and at least one byte of the audio information. The CAP has at least one control code and at least one byte of the audio information. The VAP has at least one byte of the video information and at least one byte of the audio information. The synchronization data mark the start of the UAVF when playing back the audio information and reproducing the video information. The control data provide parameters or instructions necessary for reproducing the video information.

### BACKGROUND OF THE INVENTION

1. Field of the Invention

The present invention relates to a method of encoding and decoding audio-visual information and a recording medium stored with formatted audio-visual information. More particularly, the present invention relates to appropriately formatting synchronization data, control data, audio information, and video information for being stored in a recording medium with a small storage capacity or bandwidth, thereby achieving economical and beneficial reproduction of the audio-visual information.

2. Description of the Related Art

Among various currently used recording media, optical storage media are able to provide relatively large storage capacity with a high density through using an extremely short wavelength of a laser beam. The most commonly used optical storage media are compact disks (CD), which may be categorized as a compact disk-digital audio (CD-DA), a compact disk-read only memory (CD-ROM), a compact disk-interactive (CD-I), a video compact disk (VCD), and a digital versatile disk (DVD). The CD-DA may be used to record music data. The CD-ROM has two data formats of “Mode 1” for storing computer data and “Model 2” for storing audio-visual information. The CD-I provides a real-time interactive function and stores sound, still picture, and motion picture data. The VCD and DVD employ a technique of motion picture experts group (MPEG) to compress audio-visual information.

Although the VCD and DVD can store a large capacity of audio-visual information and achieves high quality real-time music play back and image reproduction, which is a remarkable success in industrial and entertainment business, the applications of the VCD and DVD to recording, playing back, and reproducing the audio-visual information are unfortunately subjected to the following disadvantages.

In order to store a tremendous amount of audio-visual information within a finite space on the VCD and DVD, it is necessary to compress the audio-visual information through using the complicated MPEG technique. As a result, the method of encoding the data as well as the encoder that executes such encoding method become much more complicated. Additionally, a complicated decoder and a specially designed audio-visual reproducing device are required for reproducing the compressed audio-visual information stored on the VCD and DVD. For example, a DVD player, instead of a CD-DA player, is necessary for playing the DVD in order to reproduce the stored audio-visual information. As well known by people, the DVD player is more expensive than the CD-DA player. Such difference in price obviously results from the complicated decoding method and decoder employed within the DVD player.

### SUMMARY OF THE INVENTION

The complication and high cost of the current audio-visual information apparatus have already prevented the circulation and usage of the audio-visual information. Especially for entertainment and education applications serving children and young people, it is desired to provide an economical and beneficial solution to the recording, playing back, and reproducing of the audio-visual information.

Therefore, an object of the present invention is to provide a method of encoding and a method of decoding audio-visual information for easily, economically, and effectively recording, playing back, and reproducing the audio-visual information.

Another object of the present invention is to provide a recording medium stored with formatted audio-visual information, for achieving easy, economical, and effective applications of recording, playing back, and reproducing the audio-visual information.

Although the present invention is usually applied to store a reduced amount of audio-visual information in a small-capacity recording medium, an acceptable degree of audio-visual reproducing quality is successively obtained. In one embodiment of the present invention, the methods of encoding and decoding the audio-visual information may be applied to the CD-DA. Conventionally, the CD-DA can record no information but the normal music data, and the CD-DA player can play back no optical media but the CD-DA. However, the present invention discloses an appropriate format that is named “universal audio-video frame format” by the Inventors, for effectively storing the audio-visual information in the CD-DA. Consequently, the circulation of the audio-visual information is facilitated and there will be much more applications developed on the basis of the present invention since the high quality play back and reproduction of the audio-visual information can be performed by simply using the low-cost CD-DA player.

The methods of encoding and decoding audio-visual information according to the present invention are preferably used for the recording medium with a small storage capacity or bandwidth, such as the CD-DA, the flash memory of the cellular phone, and the like. The recording medium according to the present invention is preferably used for storing the video information to be reproduced on an image display device with a small size or resolution, such as a 216-pixel by 160-pixel liquid crystal display.

According to one aspect of the present invention, a method of encoding audio-visual information is provided. Audio information having a plurality of bytes is prepared. Video information having a plurality of bytes is prepared. At least one synchronization field is configured in the audio information to form at least one synchronization-audio packet (SAP). Each of the at least one SAP has at least one byte of the audio information. At least one control field is configured in the audio information to form at least one control-audio packet (CAP). Each of the at least one CAP has at least one byte of the audio information. At least one video field is configured and the audio information and the video information are merged to form at least one video-audio packet (VAP). Each of the at least one VAP has at least one byte of the audio information. The at least one SAP, the at least one CAP, and the at least one VAP are combined to form at least one universal audio-video frame (UAVF). The at least one UAVF is recorded in a recording medium. The at least one synchronization field stores at least one synchronization data for marking a start of the at least one UAVF. The at least one control field stores at least one control data for reproducing the video information.

According to another aspect of the present invention, a recording medium of audio-visual information is provided. Plural bytes of audio information are recorded in the recording medium for playing back as sound. Plural bytes of video information are recorded in the recording medium for reproducing as image. At least one synchronization-audio packet (SAP) is recorded in the recording medium. Each of the at least one SAP has a synchronization field and a first audio field. The first audio field stores at least one byte of the audio information. At least one control-audio packet (CAP) is recorded in the recording medium. Each of the at least one CAP has a control field and a second audio field. The second audio field stores at least one byte of the audio information. At least one video-audio packet (VAP) is recorded in the recording medium. Each of the at least one VAP has a video field and a third audio field. The third audio field stores at least one byte of the audio information. The at least one SAP, the at least one CAP, and the at least one VAP are combined to form the at least one UAVF.

According to still another aspect of the present invention, a method of decoding audio-visual information is provided. The audio-visual information is formatted by at least one universal audio-video frame (UAVF) having at least one synchronization-audio packet (SAP), at least one control-audio packet (CAP), and at least one video-audio packet (VAP). Data stored in at least one synchronization field of the at least one SAP is detected for determining a start of the at least one UAVF. A first portion of the audio information is accessed from the at least one SAP. Data stored in at least one control field of the at least one CAP is detected. A second portion of the audio information is accessed from the at least one CAP. The video information stored in at least one video field of the at least one VAP is accessed. A third portion of the audio information is accessed from the at least one VAP. The video information stored in the at least one video field is reproduced in response to the data stored in the at least one control field. The first to third portions of the audio information are played back.

### BRIEF DESCRIPTION OF THE DRAWINGS

The above-mentioned and other objects, features, and advantages of the present invention will become apparent with reference to the following descriptions and accompanying drawings, wherein:

FIG. 1 is a flow chart showing a method of encoding audio-visual information according to the present invention;

FIG. 2(a) is a schematic diagram showing a format of a synchronization-audio packet according to the present invention;

FIG. 2(b) is a schematic diagram showing a format of a control-audio packet according to the present invention;

FIG. 2(c) is a schematic diagram showing a format of a video-audio packet according to the present invention;

FIG. 2(d) is a schematic diagram showing a format of a universal audio-video frame packet according to the present invention;

FIG. 3 is a flow chart showing a method of decoding audio-visual information according to the present invention;

FIG. 4(a) is a circuit block diagram showing an encoder for performing the encoding method shown in FIG. 1; and

FIG. 4(b) is a circuit block diagram showing a decoder for performing the decoding method shown in FIG. 3.

### DETAILED DESCRIPTION OF THE PREFERRED EMBODIMENTS

The preferred embodiments according to the present invention will be described in detail with reference to the drawings.

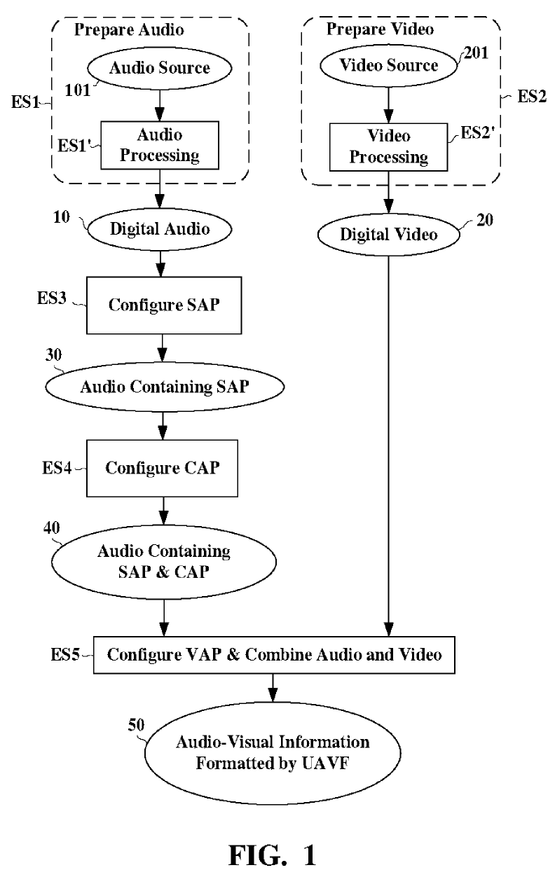

FIG. 1 is a flow chart showing a method of encoding audio-visual information according to the present invention. Referring to FIG. 1, digital audio information 10 is prepared in a step ES1 and digital video information 20 is prepared in a step ES2. The steps ES1 and ES2 may be executed simultaneously or in sequence. In the step ES1, the digital audio information 10 may be generated from an audio source 101 by performing an audio signal processing step ES1′. The audio source 101 may include an analog source and/or a digital source. For example, the audio signal processing step ES1′ may consist of sampling, sub-sampling, tuning for the audio quality, and the like, which are well known by one skilled in the art. The audio signal processing step ES1′ may also include a conventional audio compression technique such that the digital audio information 10 is generated by compression. In one embodiment of the present invention, the audio source 101 may be stereo 16-bit wave format audio data, and converted into mono 8-bit wave format audio data through the sub-sampling of the audio signal processing step ES1′. In a case where the digital audio information 10 is directly provided, i.e. the audio source 101 is the mono 8-bit wave format audio data, the additional audio signal processing step ES1′ becomes unnecessary.

In a step ES2, the digital video information 20 may be generated from a video source 201 by performing a video signal processing step ES2′. The video source 201 may include an analog source and/or a digital source. For example, the video signal processing step ES2′ may consist of sampling, sub-sampling, tuning for the video quality, and the like, which are well known by one skilled in the art. The video signal processing step ES2′ may also include a conventional video compression technique such that the digital video information 20 is generated by compression. In one embodiment of the present invention, the video source 201 may be 24-bit bitmap format video data, and converted into 4-bit bitmap format video data through the sub-sampling of the video signal processing step ES2′. In a case where the digital video information 20 is directly provided, i.e. the video source 201 is the 4-bit bitmap format video data, the additional video signal processing step ES2′ becomes unnecessary.

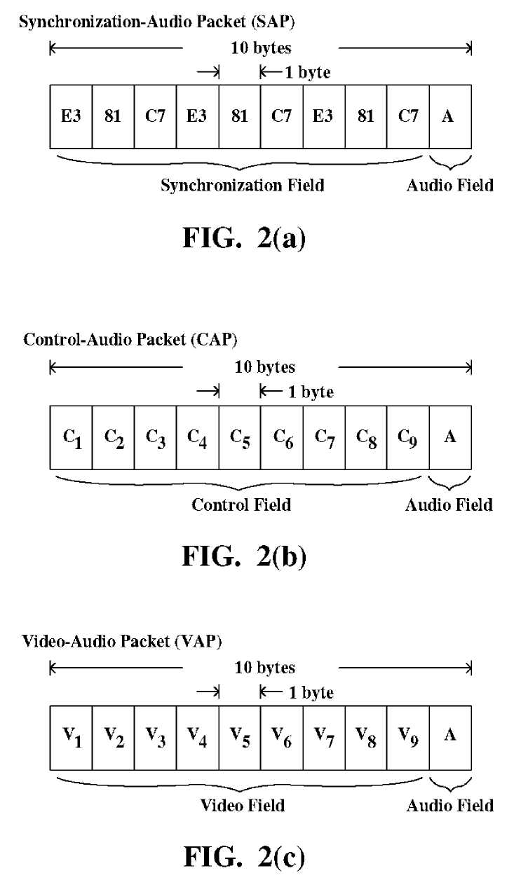

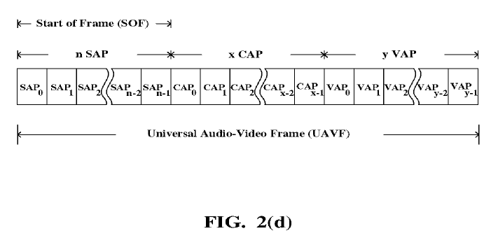

In a step ES3, at least one synchronization field is configured in the digital audio information 10 and then filled with synchronization data, thereby generating audio information 30 containing at least one synchronization-audio packet (SAP). FIG. 2(a) is a schematic diagram showing the format of the SAP according to the present invention. Referring to FIG. 2(a), the SAP includes one synchronization field and one audio field. The synchronization field is arranged to store the synchronization data while the audio field is arranged to store the audio information. In one embodiment, the synchronization field accommodates nine bytes of the synchronization data while the audio field accommodates one byte of the audio information. In one embodiment, the synchronization data includes the nine-byte data consisting of nine binary codes E1, 81, C7, E1, 81, C7, E1, 81, and C7. Each byte has eight bits. In this embodiment, the synchronization data is actually formed by repeating the three codes E1, 81, and C7 three times in order to reduce the chance of error upon detecting. The nine bytes of the synchronization data and the one byte of the audio information A together form a ten-byte SAP. It should be noted that in the SAP according to the present invention, the synchronization data is not limited to the nine bytes consisting of the binary codes E1, 81, C7, E1, 81, C7, E1, 81, and C7, and may be implemented by other binary codes and/or other number of bytes. When the synchronization field provides an available capacity larger than the amount of the synchronization data to be stored, the remaining space of the synchronization field may be filled with meaningless dummy data. Moreover, the SAP according to the present invention is not limited to having one byte of the audio information, and may have two or more than two bytes of the audio information, depending on the amount of the audio information needed to be stored and the available capacity (or bandwidth) of the recording medium. In one embodiment of the present invention, the synchronization data is used for the synchronization of the audio-visual information during the play back and reproduction, and serves as a frame marker.

In a step ES4, at least one control field is configured in the digital audio information 30 containing the SAP, and then filled with control data, thereby generating audio information 40 containing both of the SAP and at least one control-audio packet (CAP). FIG. 2(b) is a schematic diagram showing the format of the CAP according to the present invention. Referring to FIG. 2(b), the CAP includes one control field and one audio field. The control field is arranged to store the control data while the audio field is arranged to store the audio information. In one embodiment, the control field accommodates nine bytes of the control data while the audio field accommodates one byte of the audio information. In one embodiment, the control data includes the nine-byte data designated with reference symbols C₁ to C₉, as shown in the figure. The nine bytes of the control data and the one byte of the audio information A together form a ten-byte CAP. It should be noted that in the CAP according to the present invention, the control data is not limited to the nine bytes and may be implemented by other number of bytes. When the control field provides an available capacity larger than the amount of the control data to be stored, the remaining space of the control field may be filled with meaningless dummy data. In one embodiment of the present invention, the control field is even completely filled with the meaningless dummy data because none of the control data is added during the encoding procedure. Moreover, the CAP according to the present invention is not limited to having one byte of the audio information, and may have two or more than two bytes of the audio information, depending on the amount of the audio information needed to be stored and the available capacity (or bandwidth) of the recording medium. In one embodiment of the present invention, the control data provides parameters and instructions regarding image processing for the reproduction of the audio-visual information.

In a step ES5, at least one video field is configured while the digital audio information 40 containing the SAP and the CAP is merged with the digital video signal 20, thereby generating an audio-visual information 50 formatted by at least one universal audio-video frame (UAVF) consisting of at least one SAP, at least one CAP, and at least one video-audio packet (VAP). FIG. 2(c) is a schematic diagram showing the format of the VAP according to the present invention. Referring to FIG. 2(c), the VAP is formed by one video field and one audio field. The video field is arranged to store the video information while the audio field is arranged to store the audio information. In one embodiment, the video field accommodates nine bytes of the video information while the audio field accommodates one byte of the audio information. In one embodiment, the video information stored in the video field includes the nine-byte data designated with reference symbols V1 to Vg, as shown in the figure. The nine bytes of the video information and the one byte of the audio information A together form a ten-byte VAP. It should be noted that in the VAP according to the present invention, the video information is not limited to the nine bytes and may be implemented by other number of bytes, depending on the amount of the video information needed to be stored and the available capacity (or bandwidth) of the recording medium. Moreover, the VAP according to the present invention is not limited to having one byte of the audio information, and may have two or more than two bytes of the audio information, depending on the amount of the audio information needed to be stored and the available capacity (or bandwidth) of the recording medium.

FIG. 2(d) is a schematic diagram showing the format of the UAVF according to the present invention. Referring to FIG. 2(d), a single UAVF is constructed by n synchronization-audio packets SAP₀ to SAPₙ₋₁, x control-audio packets CAP₀ to CAPₓ₋₁, and y video-audio packets VAP₀ to VAP_{y-1}, wherein n, x, and y are all positive integers. Since the synchronization data serves as the frame marker, the synchronization-audio packets SAP₀ to SAPₙ₋₁ may also be called the start of frame (SOF).

In one embodiment of the present invention, the recording medium is implemented by a CD-DA with a diameter of 108 mm for storing the audio-visual information formatted by the UAVF. Typically, the specification of the CD-DA output is 16 bits per channel at a rate of 44.1 K samples per second. Due to dual channels (i.e. right and left channels) the CD-DA provides a bandwidth of 44,100*16*2/8=1 76,400 byte/sec, provided that each byte has eight bits. When the frame rate is set as 9 frames per second, the storage capacity of the CD-DA is 176,400/9=1 9,600 bytes during one frame, i.e. 1/9 seconds. When a display with a resolution of 216-pixel by 160-pixel is employed, the video information required for displaying one frame is 216*160*4/8=17,280 bytes if each pixel is expressed by a 4-bit data. When the audio information is stored in the CD-DA under a condition that every ten bytes of data contains one byte of the audio information, 1,960 bytes of the audio information can be stored during one frame ( 1/9 seconds). That is, the sampling rate of the audio information is 1,960*9=17.64K per second.

Because the audio information and the video information are mixed together and then recorded within the two channels of the CD-DA, it is necessary to use the synchronization data for identifying the start of each UAVF and the position of the audio information. As described above, the storage capacity of the CD-DA during one frame ( 1/9 seconds) is 19,600 bytes wherein 17,280 bytes are arranged to store the video information and 1,960 bytes are arranged to store the audio information. As a result, 360 bytes are available for storing the synchronization data and/or the control data, such as the gamma table or other parameters regarding the play back and reproduction of the audio-visual information.

It should be noted that although the encoding method according to the present invention may effectively store the audio-visual information on the CD-DA with the diameter of 108 mm, the present invention is not limited to this and may be applied to store the audio-visual information on various types of recording media, including a cassette tape, a floppy disk, a semiconductor memory, a game card, a compact disk with an arbitrary diameter, and so on.

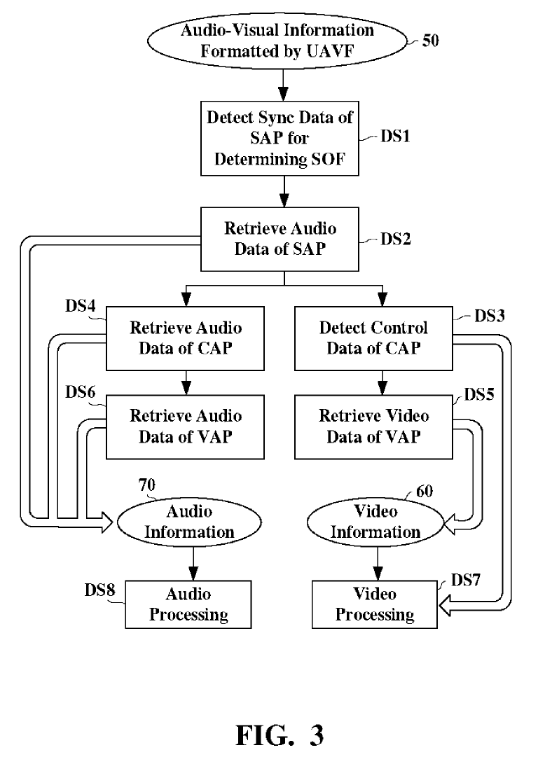

FIG. 3 is a flow chart showing a method of encoding audio-visual information according to the present invention. Referring to FIG. 3, at first is provided the audio-visual information 50 formatted by the UAVF according to the present invention. In a step DS1, the synchronization data of the SAP are detected in order to determine the start of the UAVF. In a step DS2, the audio information of the SAP is retrieved. In a step DS3, the control data of the CAP are detected. In a step DS4, the audio information of the CAP is retrieved. In a step DS5, the video information of the VAP is retrieved. In a step DS6, the audio information of the VAP is retrieved. In a step DS7, the video information 60 from the VAP is subjected to signal processing in response to the control data from the CAP, for achieving the reproduction of the video information. In one embodiment of the present invention, the signal processing for the reproduction of the video information during the step DS7 is implemented in accordance with the control data pre-installed in a video processor instead of the CAP. On the other hand, if the step DS3 for detecting the control data is subjected to some error, then the reproduction of the video information in the step DS7 may also be performed in accordance with the control data pre-installed in the video processor. In a step DS8, an audio information processing is performed for playing back the audio information 70 from the SAP, the CAP, and the VAP.

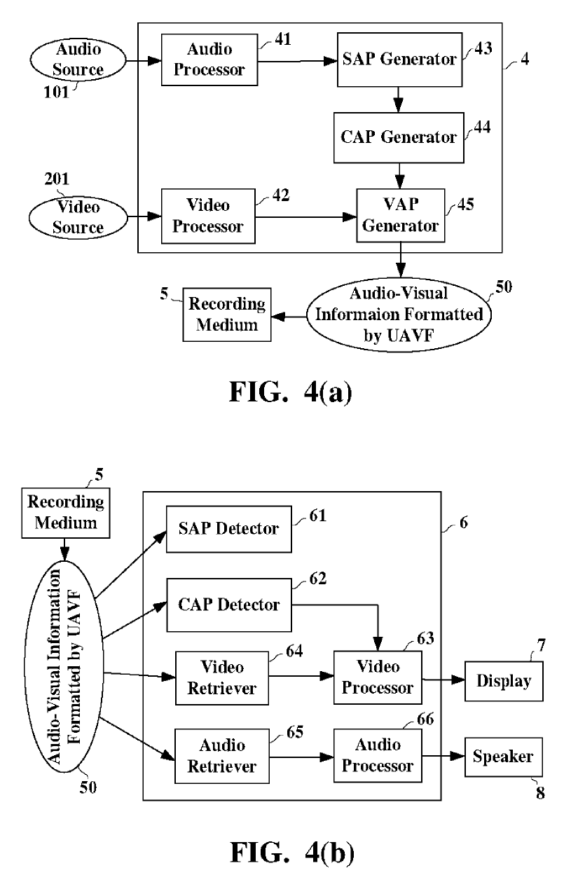

FIG. 4(a) is a circuit block diagram showing an encoder 4 for performing the encoding method shown in FIG. 1. Referring to FIGS. 1 and 4(a), the audio source 101 is transformed to the digital audio information 10 through an audio signal processor 41 while the video source 201 is transformed to the digital video information 20 through a video signal processor 42. A synchronization-audio packet generator 43 is provided for configuring at least one synchronization field in the digital audio information 10 and then filling it with the synchronization data, thereby generating the audio information 30 containing the SAP. A control-audio packet generator 44 is provided for configuring at least one control field in the digital audio information 30 containing the SAP and then filling it with the control data, thereby generating the audio information 40 containing the SAP and the CAP. A video-audio packet generator 45 is provided for configuring at least one video field and then merging the audio information 40 containing the SAP and the CAP with the digital video information, thereby generating the audio-visual information 50 formatted in accordance with the UAVF consisting of the SAP, the CAP, and the VAP. The encoder 4 according to the present invention may be implemented by software such as a computer program or by hardware such as an application specific integrated circuit (ASIC). The audio-visual information 50 formatted in accordance with the UAVF may be stored in a recording medium 5. In one embodiment, the recording medium 5 is a CD-DA with a diameter of 108 mm.

FIG. 4(b) is a circuit block diagram showing a decoder 6 for performing the decoding method shown in FIG. 3. Referring to FIGS. 3 and 4(b), the audio-visual information 50 formatted in accordance with the UAVF is provided to the decoder 6 from the recording medium 5, such as a CD-DA with a diameter of 108 mm. A synchronization-audio packet detector 61 is provided for detecting the synchronization data of the SAP in the audio-visual information 50 formatted in accordance with the UAVF, in order to determine the start of each UAVF. A control-audio packet detector 62 is provided for detecting the control data of the CAP in the audio-visual information 50 formatted in accordance with the UAVF, and transmitting the control data to a video information processor 63. A video information retriever 64 is provided for accessing the video information 60 of the VAP in the audio-visual information 50 formatted in accordance with the UAVF. In response to the detected control data and the accessed video information 60, a video information processor 63 controls a display 7 to achieve the image reproduction. In one embodiment, the video information processor 63 performs the reproduction of the video information through using the control data from the CAP. In another embodiment, the video information processor 63 is pre-installed with the control data for the reproduction of the video information. The pre-installed control data may be invoked for the reproduction of the video information even if the control-audio packet detector 62 is subjected to some error during detection. An audio information retriever 65 is provided for accessing the audio information 70 of the SAP, the CAP, and the VAP in the audio-visual information 50 formatted in accordance with the UAVF. In response to the accessed audio information 70, an audio information processor 66 controls a speaker 8 to achieve the audio play back. The decoder 6 according to the present invention may be implemented by software such as a computer program or by hardware such as an application specific integrated circuit (ASIC).

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

1. A method of encoding audio-visual information comprising:
preparing audio information having a plurality of bytes;
preparing video information having a plurality of bytes;
configuring at least one synchronization field in the audio information to form at least one synchronization-audio packet (SAP), each of the at least one SAP having at least one byte of the audio information;
configuring at least one control field in the audio information to form at least one control-audio packet (CAP), each of the at least one CAP having at least one byte of the audio information;
configuring at least one video field and merging both of the audio information and the video information to form at least one video-audio packet (VAP), each of the at least one VAP having at least one byte of the audio information; and
combining the at least one SAP, the at least one CAP, and the at least one VAP to form at least one universal audio-video frame (UAVF).

2. The method according to claim 1, wherein:
the at least one synchronization field stores at least one synchronization data for marking a start of the at least one UAVF.

3. The method according to claim 1, wherein:
the at least one control field stores at least one control data for reproducing the video information.

4. The method according to claim 1, wherein:
for each of the at least one SAP, the at least one byte of the audio information is arranged behind the at least one synchronization field;
for each of the at least one CAP, the at least one byte of the audio information is arranged behind the at least one control field; and
for each of the at least one VAP, the at least one byte of the audio information is arranged behind the at least one video field.

5. The method according to claim 1, wherein:
each of the at least one synchronization field stores at least nine bytes of data;
each of the at least one control field stores at least nine bytes of data; and
each of the at least one video field stores at least nine bytes of data.

6. The method according to claim 1, wherein:
each of the at least one control field stores nine binary codes of E1, 81, C7, E1, 81, C7, E1, 81, and C7.

7. The method according to claim 1, further comprising:
recording the at least one UAVF in a recording medium.

8. The method according to claim 7, wherein:
the recording medium is a compact disk-digital audio (CD-DA) with a diameter of 108 mm.

9. A recording medium for audio-visual information comprising:
plural bytes of audio information, recorded in the recording medium, for playing back as sound;
plural bytes of video information, recorded in the recording medium, for reproducing as image;
at least one synchronization-audio packet (SAP), recorded in the recording medium, each of the at least one SAP having a synchronization field and a first audio field, in which the first audio field stores at least one byte of the audio information;
at least one control-audio packet (CAP), recorded in the recording medium, each of the at least one CAP having a control field and a second audio field, in which the second audio field stores at least one byte of the audio information; and
at least one video-audio packet (VAP), recorded in the recording medium, each of the at least one VAP having a video field and a third audio field, in which the third audio field stores at least one byte of the audio information, thereby:
combining the at least one SAP, the at least one CAP, and the at least one VAP to form the at least one UAVF.

10. The recording medium according to claim 9, wherein:
the synchronization field stores at least one synchronization data for marking a start of the at least one UAVF.

11. The recording medium according to claim 9, wherein:
the control field stores at least one control data for reproducing the video information.

12. The recording medium according to claim 9, wherein:
the first audio field is arranged behind the synchronization field;
the second audio field is arranged behind the control field; and
the third audio field is arranged behind the video field.

13. The recording medium according to claim 9, wherein:
the synchronization field stores at least nine bytes of data;
the control field stores at least nine bytes of data; and
the video field stores at least nine bytes of data.

14. The recording medium according to claim 9, wherein:
the synchronization field stores nine binary codes of E1, 81, C7, E1, 81, C7, E1, 81, and C7.

15. The recording medium according to claim 9, wherein:
the recording medium is a compact disk-digital audio (CD-DA) with a diameter of 108 mm.

16. A method of decoding audio-visual information formatted by at least one universal audio-video frame (UAVF) having at least one synchronization-audio packet (SAP), at least one control-audio packet (CAP), and at least one video-audio packet (VAP), the method comprising:
detecting data stored in a synchronization field of the at least one SAP for determining a start of the at least one UAVF;
accessing a first portion of the audio information from the at least one SAP;
detecting data stored in a control field of the at least one CAP;
accessing a second portion of the audio information from the at least one CAP;
accessing the video information stored in a video field of the at least one VAP;
accessing a third portion of the audio information from the at least one VAP;
reproducing the video information stored in the video field in response to the data stored in the control field; and
playing back the first to third portions of the audio information.

17. The method according to claim 16, wherein:
for each of the at least one SAP, the first portion of the audio information is arranged behind the synchronization field;
for each of the at least one CAP, the second portion of the audio information is arranged behind the control field; and
for each of the at least one VAP, the third portion of the audio information is arranged behind the video field.

18. The method according to claim 16, wherein:
the synchronization field stores at least nine bytes of data;
the control field stores at least nine bytes of data; and
the video field stores at least nine bytes of data.

19. The method according to claim 16, wherein:
the synchronization field stores nine binary codes of E1, 81, C7, E1, 81, C7, E1, 81, and C7.

20. The method according to claim 16, wherein:
the at least one UAVF is recorded in a compact disk-digital audio (CD-DA) with a diameter of 108 mm.
